(19) United States
(12) Patent Application Publication
(10) Pub. No.: US 2007/0047432 A1
(43) Pub. Date: Mar. 1, 2007

(54) Apparatus and method for reducing transmission overhead in a broadband wireless communication system

(75) Inventors: Young-Kwon Cho, Suwon-si (KR); Jung-Soo Woo, Suwon-si (KR); Su-Ryong Jeong, Suwon-si (KR); Deok-Ki Kim, Seongnam-si (KR); Young-Kyun Kim, Sungnam-si (KR); Dong-Seek Park, Yongin-si (KR); Joon-Young Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/512,200

(22) Filed: Aug. 30, 2006

(30) Foreign Application Priority Data
Aug. 30, 2005 (KR) 2005-0079936

(51) Int. Cl. H04J 11/00

(52) U.S. Cl. 370/203

(57) ABSTRACT

An apparatus and method for reducing transmission overhead in a broadband wireless communication system are provided. In a transmitter in a broadband wireless communication system where total time resources are divided according to lengths of transmission data and the transmission data are allocated to the divided time resources, a header generator generates a header including data allocation information and control information for a frame to be transmitted, and a traffic channel constructer constructs a traffic channel by combining the header with a burst.

### CROSS-REFERENCE TO RELATED PATENT APPLICATIONS

This application claims the benefit under 35 U.S.C. § 119 (a) of a Korean Patent application filed in the Korean Intellectual Property Office on Aug. 30, 2005 and assigned Serial No. 2005-79936, the entire disclosure of which is hereby incorporated by reference.

### BACKGROUND OF THE INVENTION

1. Field of the Invention

The present invention relates generally to an apparatus and method for reducing transmission overhead in a broadband wireless communication system. More particularly, the present invention relates to a frame configuration method for reducing transmission overhead, and a transmitting and receiving apparatus for supporting the same in an Orthogonal Frequency Division Multiplexing (OFDM) broadband wireless communication system.

2. Description of the Related Art

With the recent advent of a wireless multimedia era, the rapid increasing demands for high-speed transmission of a large amount of data on radio channels have become a driving force behind active researches concerning provisioning of services supporting high-speed data transmission capability, high Quality of Service (QoS), severe multipath fading channels, and high mobility.

While 3rd Generation (3G) communications systems support up to 2 Mbps for stationary users, 4th Generation (4G) communication systems aim at 1 Gbps for stationary users or pedestrians under a Wireless Local Area Network (WLAN) environment and 100 Mbps for vehicles under a Wireless Metropolitan Area Network (WMAN) environment. However, since high-speed data transmission on radio channels suffers from high error rate due to multipath interference, a radio access technique suitable for radio channels is needed.

In order to reduce errors caused by the multipath interference of radio channels, Institute of Electrical and Electronics Engineers (IEEE) 802.16 systems have been developed in which the physical channels of the WMAN system operate in Orthogonal Frequency Division Multiplexing (OFDM) and Orthogonal Frequency Division Multiple Access (OFDMA). These IEEE 802.16 systems realize high-speed data transmission by sending physical channel signals on a plurality of subcarriers.

FIG. 1 illustrates a frame structure in a typical OFDMA wireless communication system. The following description is made with the appreciation that conceptual time and frequency data units are a subchannel and a symbol, respectively and a minimum data unit for one user is defined by one subchannel and one symbol. The vertical axis represents (L+1) frequency resource units, that is, (L+1) subchannels numbered from s to (s+L), and the horizontal axis represents time resource units, that is, OFDM symbols divided into (M+1) downlink OFDM symbols numbered from k to (k+M) and N uplink OFDM symbols numbered from (k+M+1) to (k+M+N). A Transmit/Receive Transition Gap (TTG) intervenes as a time guard region between the downlink and uplink OFDM symbols.

Referring to FIG. 1, an OFDMA frame includes a Preamble, a Frame Control Header (FCH), a downlink (DL)-MAP, an uplink (UL)-MAP, and DL-Bursts for the downlink, and UL-Bursts for the uplink.

The Preamble is used for users to acquire timing and frequency synchronization and to acquire cell information. The FCH provides information required for DL-MAP decoding. The DL-MAP includes information identifying users to receive DL-Bursts with actual information data transmitted from a BS, and information indicating the positions of the DL-Bursts.

The UL-Bursts carry actual data information from users, that is, Mobile Stations (MSs). The UL-MAP indicates MSs to send uplink data and positions in a frame at which they are supposed to send the uplink data, as set by the BS.

At least one subchannel and at least one symbol are taken to send one DL-Burst or one UL-Burst. Since symbols are arranged physically in time sequence, a kth symbol is followed by a (k+1)th symbol and finally by a (k+M+N)th symbol. In contrast, an sth subchannel and an (s+1)th subchannel may or may not be physically adjacent because the OFDM subcarriers of a subchannel are rearranged logically, not being successive physically due to the frequency selective nature of a radio channel when the subchannel experiences the radio channel in OFDM.

Aside from the MAP information, burst preambles are included in the Bursts in a one-to-one correspondence with data bursts in order to indicate a modulation scheme and a code rate for a corresponding data burst.

FIG. 2 is a flowchart illustrating an operation for configuring a frame using a MAP channel in a conventional OFDM wireless communication system. The following description is made of generation and transmission of the frame structure illustrated in FIG. 1, by way of example.

Referring to FIG. 2, a transmitter determines whether there exists data to users in a cell in step 201. In the presence of the transmission data, the transmitter determines transmission data to be allocated to a current frame by scheduling in step 203.

In step 205, the transmitter constructs a MAP channel by generating information about allocation of data bursts to the transmission data. The data burst allocation information contains the modulation level of a corresponding burst, the start (symbol offset and subchannel offset) of the burst, the length of the burst (the number of symbols and the number of subchannels), and the User Identifier (UID) of a user to receive the burst. The transmitter constructs data bursts for a traffic channel by adding headers with other control information to the user data in step 207. The headers are called burst preambles containing the modulation schemes and coding rates of the corresponding bursts.

After constructing the MAP channel and the traffic channel, the transmitter re-constructs the traffic channel data bursts based on the MAP channel information in step 209. That is, the data bursts are reconfigured according to the start points, length and UIDs of the data bursts, included in the MAP channel.

In step 211, the transmitter sends the frame data through an antenna and then ends the algorithm.

FIG. 3 is a flowchart illustrating an operation for receiving a frame using a MAP channel in the conventional OFDM wireless communication system. The frame sent by the transmitter in the procedure illustrated in FIG. 2 is received as follows.

Referring to FIG. 3, a receiver receives a MAP channel in a predetermined area of a received frame and recovers the MAP channel in step 301.

In step 303, the receiver determines whether the recovered MAP channel includes the UID of the receiver. In the presence of the UID, the receiver acquires data burst allocation information corresponding to the UID, such as the start, length, and modulation level of a burst.

The receiver receives traffic data based on the data burst allocation information in step 305 and recovers the traffic data by recovering the header (burst header) of the traffic data in step 307. The receiver then ends the algorithm.

As described above, the OFDM wireless communication system supports a frame structure having bursts with a variety of formats and lengths, for efficient transmission to users having various QoS levels under various environments through MAP information. That is, various bursts are configured for users according to the type of transmission data, link adaptation, scheduling process, and packet length. For example, a small-size burst is required for voice data, whereas a large-size burst is suitable for high-speed data transmission/reception.

However, in order to increase the flexibility of data allocation, the amount of control information should be increased and the increase in the resource area to which the control information is allocated. Therefore, this results in reducing the amount of resources allocated to actual data due to the limited resource.

Accordingly, there is a need for an improved apparatus and method for reducing transmission overhead in an OFDM wireless communication system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for efficiently utilizing time-frequency resources in an OFDM wireless communication system.

Another aspect of exemplary embodiments of the present invention is to provide an apparatus and method for supporting a frame structure which reduces transmission overhead in an OFDM wireless communication system.

A further aspect of exemplary embodiments of the present invention is to provide an apparatus and method for reducing transmission overhead by use of a burst preamble and configuring a variable frame in an OFDM wireless communication system.

The above aspects are achieved by providing an apparatus and method for reducing transmission overhead in a broadband wireless communication system.

According to one aspect of exemplary embodiments of the present invention, in a transmitter in a broadband wireless communication system where total time resources are divided according to lengths of transmission data and the transmission data are allocated to the divided time resources, a header generator generates a header including data allocation information and control information for a frame to be transmitted, and a traffic channel constructer constructs a traffic channel by combining the header with a burst.

According to another aspect of exemplary embodiments of the present invention, in a receiver in a broadband wireless communication system where total time resources are divided according to lengths of transmission data and the transmission data are allocated to the divided time resources, a header recoverer recovers a header including data allocation information and control information in a received frame, determines whether a UID of the receiver exists in the header, and acquires allocation information of a data burst in the presence of the UID. A reception unit receives traffic data in a time area indicated by the allocation information of the data burst, and a packet constructer acquires a traffic ID of the traffic data by recovering the control information included in the header.

According to a further aspect of exemplary embodiments of the present invention, in a transmission method in a broadband wireless communication system where total time resources are divided according to lengths of transmission data and the transmission data are allocated to the divided time resources, the length of a burst to which transmission data is to be allocated is determined according to the length of the transmission data. A header is generated which includes data allocation information and control information about the transmission data. A frame is constructed by combining the header with the burst.

According to still another aspect of exemplary embodiments of the present invention, in a reception method in a broadband wireless communication system where total time resources are divided according to lengths of transmission data and the transmission data are allocated to the divided time resources, a header in a received frame is recovered and a determination is made as to whether the header includes a UID of the receiver. In the presence of the UID, traffic data is received based on data allocation information included in the header. A service packet is assembled with the received traffic data based on control information included in the header.

### BRIEF DESCRIPTION OF THE DRAWINGS

The above and other objects, features and advantages of certain exemplary embodiments of the present invention will be more apparent from the following detailed description when taken in conjunction with the accompanying drawings, in which:

FIG. 1 illustrates a frame structure in a typical OFDMA wireless communication system;

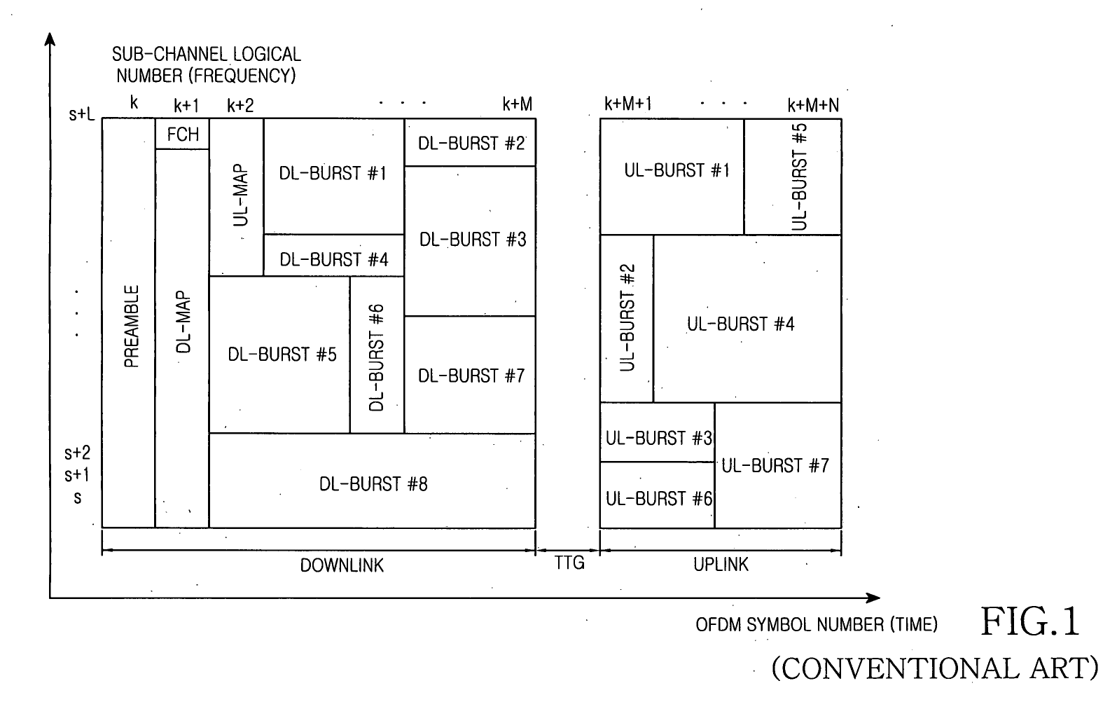

FIG. 2 is a flowchart illustrating a frame configuration procedure using a MAP channel in a conventional OFDM wireless communication system;

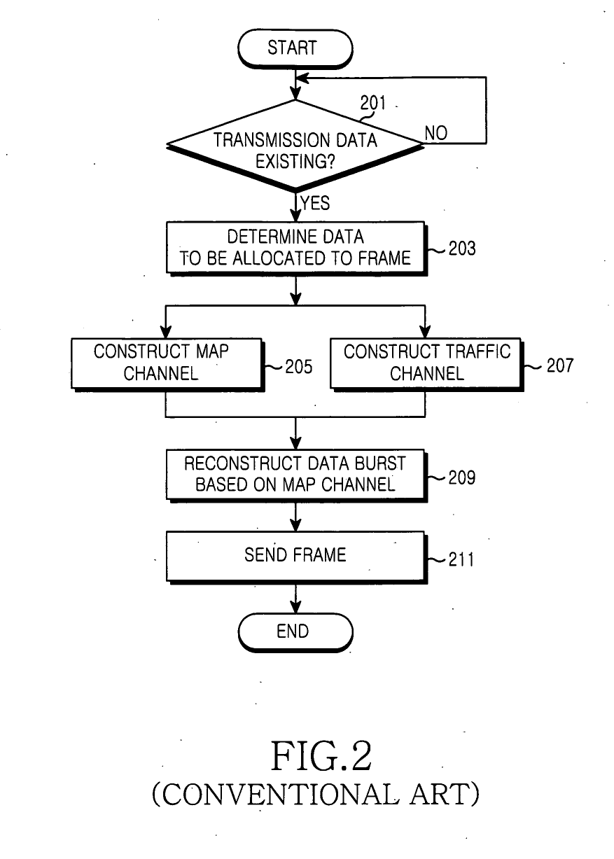

FIG. 3 is a flowchart illustrating a frame reception procedure using the MAP channel in the conventional OFDM wireless communication system;

FIG. 4 illustrates a frame structure in an OFDM wireless communication system according to an exemplary embodiment of the present invention;

FIG. 5 is a block diagram of a transmitter in the OFDM Wireless communication system according to an exemplary embodiment of the present invention;

FIG. 6 is a block diagram of a receiver in the OFDM wireless communication system according to an exemplary embodiment of the present invention;

FIG. 7 is a flowchart illustrating a frame configuration procedure in the OFDM wireless communication system according to an exemplary embodiment of the present invention; and

FIG. 8 is a flowchart illustrating a frame reception procedure in the OFDM wireless communication system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention is intended to provide a technique for efficiently utilizing time-frequency resources in a broadband wireless communication system. Specifically, the present invention provides a frame configuration method for reducing overhead generated when using a MAP channel and a transmitting and receiving apparatus supporting the same in the broadband wireless communication system. The present invention will be described in the context of an OFDMA broadband wireless communication system, by way of example.

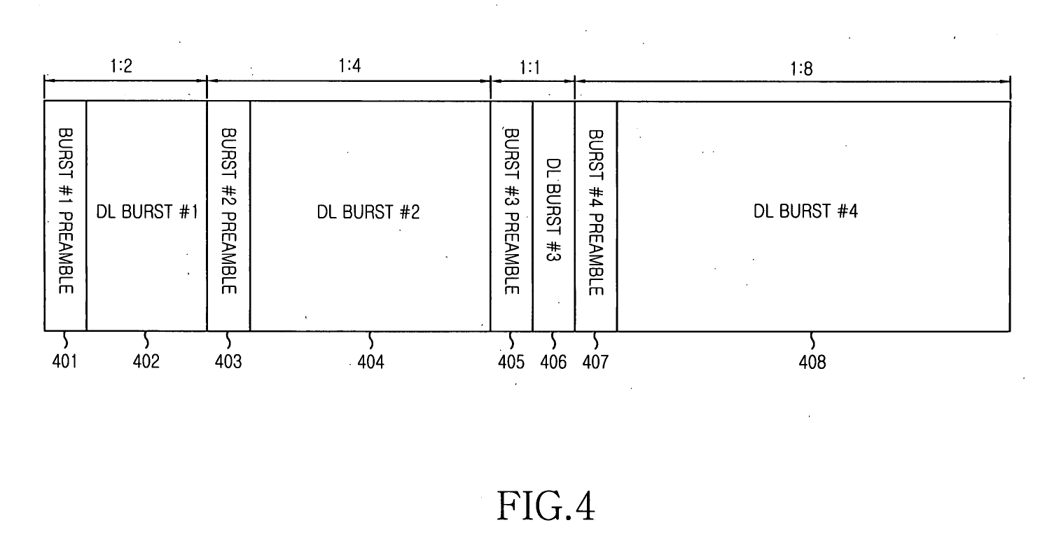

FIG. 4 illustrates a frame structure in an OFDM wireless communication system according to an exemplary embodiment of the present invention. The horizontal axis represents time resource units and the vertical axis represents frequency resource units. The following description is made of a downlink frame alone, without a description of a preamble.

Referring to FIG. 4, a frame is comprised of downlink burst preambles 401, 403, 405 and 407 and downlink bursts 402, 404, 406 and 408.

The burst preambles 401, 403, 405 and 407 are headers matched to the bursts 402, 404, 406 and 408 in a one-to-one correspondence. The burst preambles provide the modulation scheme and code rates of the data bursts, and the data allocation information of data in the bursts, inclusive of the UIDs, burst lengths, and link adaptation information of the data.

The downlink bursts 402, 404, 406 and 408 are allocated such that time resources are divided to deliver data to a plurality of users, with a total frequency band being used for each of the users.

The downlink bursts 402, 404, 406 and 408 are configured to a variety of lengths in a variety of forms to send/receive user data efficiently for users with diverse QoS requirements under various environments. In the illustrated case of FIG. 4, the ratio between the burst preamble 401 and the burst 402 (burst #1) is 1:2, the ratio between the burst preamble 403 and the burst 404 (burst #2) is 1:4, the ratio between the burst preamble 405 and the burst 406 (burst #3) is 1:1 and the ratio between the burst preamble 407 and the burst 408 (burst #3) is 1:8. Accordingly, a variable frame is configured according to the type of transmission data.

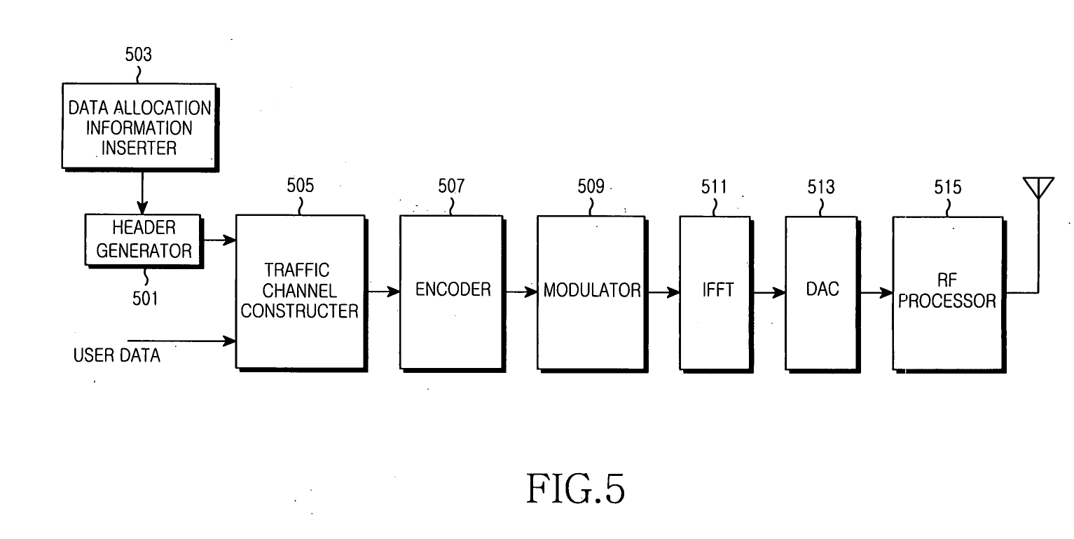

FIG. 5 is a block diagram of a transmitter in the OFDM wireless communication system according to an exemplary embodiment of the present invention.

Referring to FIG. 5, the transmitter includes a header generator 501, a data allocation information inserter 503, a traffic channel constructer 505, an encoder 507, a modulator 509, an Inverse Fast Fourier Transform (IFFT) processor 511, a Digital-to-Analog Converter (DAC) 513, and a Radio Frequency (RF) processor 515.

In operation, upon receipt of user data from a high layer, the header generator 501 generates a burst preamble using the modulation scheme, code rate, and Traffic ID (TID) of data for a burst, and data allocation information about the burst, received from the data allocation information inserter 503. The data allocation information provides the UID, length, and link adaptation information of the data.

The traffic channel constructer 505 determines a burst suitable for the length of the user data and then combines the burst with the user data with the burst preamble received from the header generator 501, thereby constructing a data burst, that is, a traffic channel.

The encoder 507 channel-encodes the data received from the traffic channel constructer 505. The modulator 509 modulates the coded data in a predetermined modulation scheme such as Binary Phase Shift Keying (BPSK), Quadrature Phase Shift Keying (QPSK), 16-ary Quadrature Amplitude Modulation (QAM), or 64 QAM.

The IFFT processor 511 IFFT-processes the modulated data to time-domain sample data (that is, an OFDM symbol). The DAC 513 converts the sample data to an analog signal. The RF processor 515 converts the analog signal to a RF signal and sends the RF signal through an antenna.

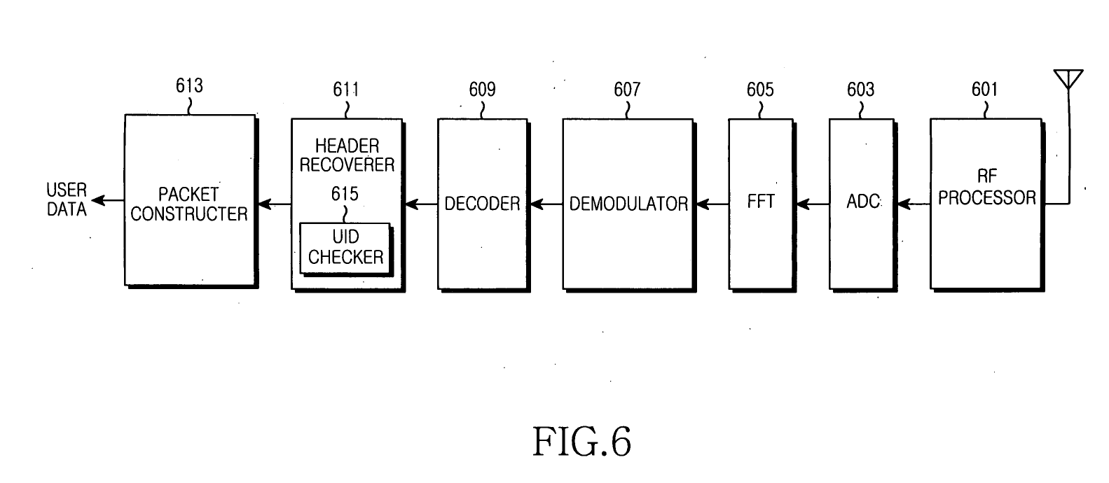

FIG. 6 is a block diagram of a receiver in the OFDM wireless communication system according to an exemplary embodiment of the present invention.

Referring to FIG. 6, the receiver includes a RF processor 601, an Analog-to-Digital Converter (ADC) 603, a Fast Fourier Transform (FFT) processor 605, a demodulator 607, a decoder 609, a header recoverer 611, a packet constructer 613, and a UID checker 615.

The RF processor 601 downconverts a RF signal received through an antenna to a baseband analog signal. The ADC 603 converts the analog signal to a digital signal, and the FFT processor 605 FFT-processes time-domain sample data received from the ADC 603 to frequency-domain data.

The demodulator 607 demodulates IFFT data in a predetermined method and the decoder 609 channel-decodes the demodulated data at a predetermined code rate, thereby recovering information data. The location (time area) and modulation level of traffic data (that is, a data burst) are acquired from a burst preamble preceding the data burst.

The header recoverer 611 separates the burst preamble from the data burst and then acquires control information and data allocation information of the data burst for the receiver. That is, the UID checker 615 of the header recoverer 611 determines whether the burst preamble includes the UID of the receiver. In the presence of the UID, the control information and data allocation information of the burst are acquired by analyzing the burst preamble. The control information and data allocation information contain a location (time area) to which the data burst is mapped, a payload length, a modulation level (for example, Modulation and Coding Scheme (MCS) level), a TID identifying a service type, and encryption information.

The burst constructer 613 assembles the traffic data separated from the burst preamble to a service packet (for example, Service Data Unit (SDU)) based on the control information received from the header recoverer 611 and provides the service packet to a high layer.

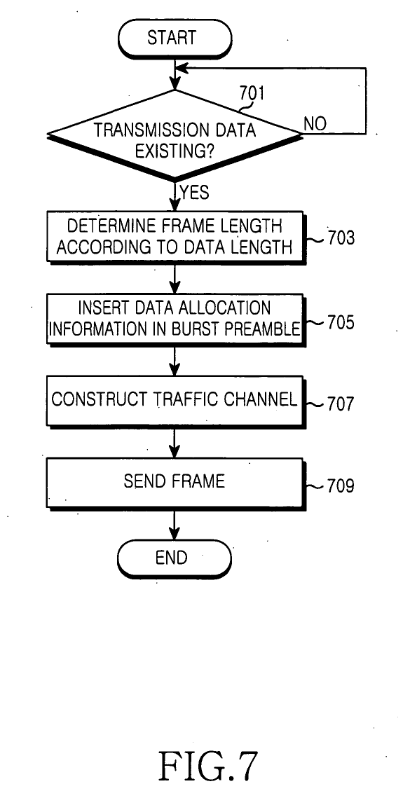

FIG. 7 is a flowchart illustrating a frame configuration procedure in the OFDM wireless communication system according to an exemplary embodiment of the present invention.

Referring to FIG. 7, the transmitter determines whether there are data to be transmitted in step 701. In the presence of the transmission data, the transmitter performs scheduling and determines burst lengths according to the lengths of the transmission data in step 703.

In step 705, the transmitter generates burst preambles with data allocation information and control information about bursts to which the transmission data are to be allocated. The data allocation information and control information contain the UIDs of the transmission data in the bursts and the modulation levels, start points, and lengths of the bursts.

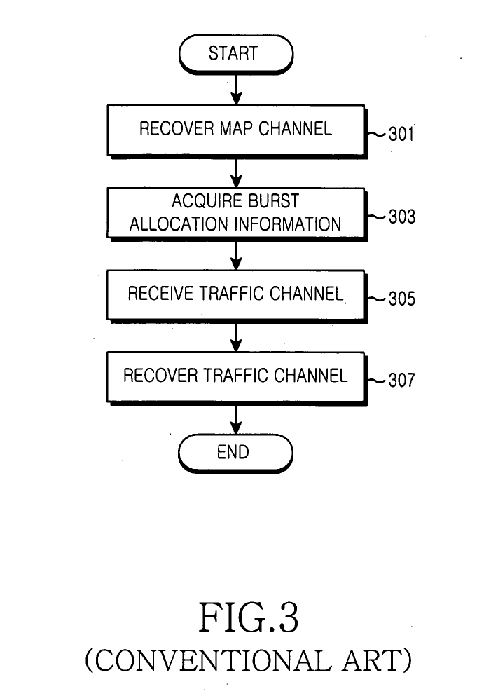

The transmitter allocates the user data to the bursts and constructs a traffic channel frame (that is, data burst) by combining the bursts with the burst preambles in step 707. That is, the traffic channel is constructed using transmission data corresponding to the UIDs set in the burst preambles according to the start points and lengths of the data bursts. For example, the frame illustrated in FIG. 3 is constructed.

The transmitter sends the frame through the antenna in step 709 and ends the algorithm.

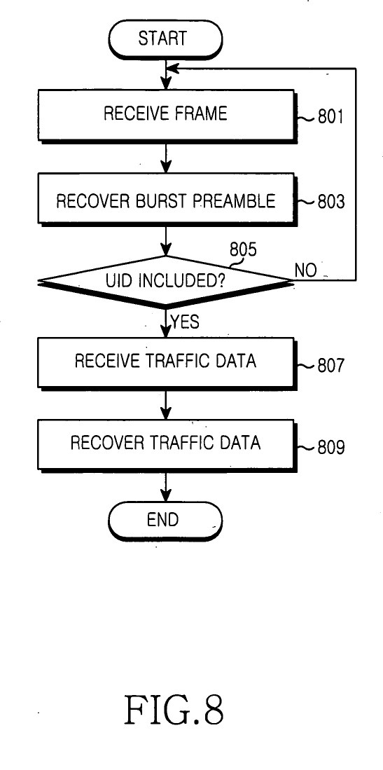

FIG. 8 is a flowchart illustrating a frame reception procedure in the OFDM wireless communication system according to an exemplary embodiment of the present invention.

Referring to FIG. 8, upon receipt of a frame in step 801, the receiver separates each burst preamble in a predetermined area of the frame and recovers the burst preamble in step 803. The burst preamble is in a one-to-one correspondence with a burst and contains data allocation information including a UID, the length of a corresponding burst, and link adaptation information, and control information including the modulation scheme, code rate, and TID of the burst.

In step 805, the receiver determines whether a UID allocated from a BS exists in the burst preamble. In the absence of the UID, the receiver returns to step 801 to receive the next frame.

In the presence of the UID, the receiver extracts data allocation information from the burst preamble and receives traffic data based on the data allocation information in step 807. Specifically, a data burst received in a predetermined time area is demodulated at an indicated modulation level and decoded. The data allocation information includes the modulation level, time-domain start, and length of the burst.

In step 809, the receiver assembles the received traffic data to a service packet based on a TID and other control information acquired from the recovered burst preamble and reproduces the service packet by a predetermined application.

In accordance with exemplary embodiments of the present invention as described above, data allocation information associated with a burst is inserted in a burst preamble, thereby reducing transmission overhead and shortening data processing time. Also, the use of a variable frame structure adaptable to a variety of users, QoS levels, or channel environments leads to efficient broadband wireless communications.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A transmitter in a wireless communication system where time resources are divided according to lengths of transmission data and the transmission data are allocated to the divided time resources, the transmitter comprising:
a header generator for generating a header including data allocation information and control information for frame transmission; and
a traffic channel constructer for constructing a traffic channel by combining the header with a burst.

2. The transmitter of claim 1, wherein the frame is configured such that a frequency band is allocated to at least one of a plurality of users and transmission data for the users are allocated according to time resources.

3. The transmitter of claim 1, wherein the data allocation information comprises at least one of a user identifier (UID) of data allocated to the frame, a time-domain start point of a burst for the data, and a length of the burst.

4. The transmitter of claim 1, wherein the control information comprises at least one of a traffic ID (TID) and a modulation scheme of data allocated to the frame.

5. The transmitter of claim 1, wherein the burst comprises a variable length according to the length of transmission data.

6. The transmitter of claim 1, wherein the traffic channel constructer determines the burst according to the length of transmission data, allocates the data to the burst, and constructs the traffic channel by combining the burst with the header.

7. The transmitter of claim 1, further comprising:
an encoder for encoding the data burst received from the traffic channel constructer at a code rate indicated by the data allocation information;
a modulator for modulating the coded signal at a modulation level indicated by the data allocation information;
an inverse fast Fourier transform (IFFT) processor for IFFT-processing the modulated data; and
a radio frequency (RF) processor for converting sample data received from the IFFT processor to a RF signal and transmitting the RF signal through an antenna.

8. A receiver in a wireless communication system where time resources are divided according to lengths of transmission data and the transmission data are allocated to the divided time resources, the receiver comprising:
a header recoverer for recovering a header including data allocation information and control information in a received frame, determining whether a user identifier (UID) of the receiver exists in the header, and acquiring allocation information of a data burst in the presence of the UID;
a reception unit for receiving traffic data in a time area indicated by the allocation information of the data burst; and
a packet constructer for acquiring a traffic identifier (ID) of the traffic data by recovering the control information included in the header.

9. The receiver of claim 8, wherein the reception unit comprises:
a radio frequency (RF) processor for converting a RF signal received through an antenna to a baseband signal;
a fast Fourier transform (FFT) processor for FFT-processing the baseband signal to frequency-domain data; and
a decoder for selecting data among the frequency-domain data according to the time-frequency area, and demodulating and decoding the selected data at a modulation level indicated by the allocation information of the data burst.

10. The receiver of claim 8, wherein the header recoverer comprises a user ID checker for checking at least one of presence and absence of the ID of the receiver in the header.

11. The receiver of claim 8, wherein the data allocation information comprises at least one of a UID of data allocated to the frame, a time-domain start point of a burst for the data, and length of the burst.

12. The receiver of claim 8, wherein the frame has a variable length according to the length of the data allocated to the frame and the receiver receives the data burst according to the time-domain start point and length of the burst indicated by the data allocation information.

13. The receiver of claim 8, wherein the control information comprises at least one of a traffic ID and a modulation scheme of the data allocated to the frame.

14. A transmission method in a wireless communication system where time resources are divided according to lengths of transmission data and the transmission data are allocated to the divided time resources, the method comprising:
determining the length of a burst to which transmission data is to be allocated according to the length of the transmission data;
generating a header comprising data allocation information and control information about the transmission data; and
constructing a frame by combining the header with the burst.

15. The transmission method of claim 14, wherein the constructing of the frame comprises constructing the frame such that a frequency band is allocated to at least one of a plurality of users and transmission data for the users are allocated according to time resources.

16. The transmission method of claim 14, wherein the burst has a variable length according to the length of the transmission data.

17. The transmission method of claim 14, wherein the data allocation information comprises at least one of a user identifier (UID) of the transmission data, a time-domain start point of the burst, and length of the burst.

18. The transmission method of claim 14, wherein the control information comprises at least one of a traffic ID and a modulation scheme of the transmission data.

19. A reception method in a wireless communication system where total time resources are divided according to lengths of transmission data and the transmission data are allocated to the divided time resources, the method comprising:
recovering a header in a received frame and determining whether the header includes a user identifier (UID) of the receiver;
receiving traffic data based on data allocation information included in the header, in the presence of the UID; and
assembling a service packet with the received traffic data based on control information included in the header.

20. The reception method of claim 19, further comprising receiving a next frame without receiving traffic data in the frame and determining at least one of presence and absence of the UID in the next frame, in the absence of the UID.

21. The reception method of claim 19, wherein the header comprises the data allocation information and control information of the frame.

22. The reception method of claim 21, wherein the data allocation information comprises at least one of a UID of data allocated to the frame, a time-domain start point of a burst for the data, and length of the burst.

23. The reception method of claim 21, wherein the control information comprises at least one of a traffic ID and a modulation scheme of the data allocated to the frame.

24. A transmitter and receiver in a wireless communication system where time resources are divided according to lengths of transmission data and the transmission data are allocated to the divided time resources, the transmitter and receiver comprising:
a header generator for generating a header including data allocation information and control information for frame transmission;
a traffic channel constructer for constructing a traffic channel by combining the header with a burst.
a header recoverer for recovering the header including data allocation information and control information in a received frame, determining whether a user identifier (UID) of the receiver exists in the header, and acquiring allocation information of a data burst in the presence of the UID;
a reception unit for receiving traffic data in a time area indicated by the allocation information of the data burst; and
a packet constructer for acquiring a traffic ID of the traffic data by recovering the control information included in the header.

25. The transmitter and receiver of claim 24, further comprising:
an encoder for encoding the data burst received from the traffic channel constructer at a code rate indicated by the data allocation information;
a modulator for modulating the coded signal at a modulation level indicated by the data allocation information;
an inverse fast Fourier transform (IFFT) processor for IFFT-processing the modulated data; and
a radio frequency (RF) processor for converting sample data received from the IFFT processor to a RF signal and transmitting the RF signal through an antenna.

26. The transmitter and receiver of claim 24, wherein the reception unit comprises:
a radio frequency (RF) processor for converting a RF signal received through an antenna to a baseband signal;
a fast Fourier transform (FFT) processor for FFT-processing the baseband signal to frequency-domain data; and
a decoder for selecting data among the frequency-domain data according to the time-frequency area, and demodulating and decoding the selected data at a modulation level indicated by the allocation information of the data burst.

27. The transmitter of claim 24, wherein the frame is configured such that a frequency band is allocated to at least one of a plurality of users and transmission data for the users are allocated according to time resources.

28. The receiver of claim 24, wherein the frame has a variable length according to the length of the data allocated to the frame and the receiver receives the data burst according to the time-domain start point and length of the burst indicated by the data allocation information.

29. The transmitter of claim 24, wherein the data allocation information comprises at least one of a user identifier (UID) of data allocated to the frame, a time-domain start point of a burst for the data, and length of the burst.

30. The transmitter of claim 24, wherein the control information comprises at least one of a traffic ID (TID) and a modulation scheme of data allocated to the frame.

31. The transmitter of claim 24, wherein the burst comprises a variable length according to the length of transmission data.

32. The transmitter of claim 24, wherein the traffic channel constructer determines the burst according to the length of transmission data, allocates the data to the burst, and constructs the traffic channel by combining the burst with the header.

33. The transmitter of claim 1, wherein the frame is configured such that a frequency band is allocated to each of users and transmission data for the users are allocated according to time resources.

34. The transmission method of claim 14, wherein the constructing of the frame comprises constructing the frame such that a total frequency band is allocated to each of users and transmission data for the users are allocated according to time resources.
